(19) United States
(12) Patent Application Publication
(10) Pub. No.: US 2010/0263584 A1
(43) Pub. Date: Oct. 21, 2010

(54) DISPLAY DEVICE FOR GENERATING A CONTOURED FORM

(75) Inventor: Manfred Süss, Remchingen (DE)

Correspondence Address: FOLEY AND LARDNER LLP;SUITE 500, 3000 K STREET NW, WASHINGTON, DC, 20007, US

(73) Assignee: Johnson Controls Automotive Electronics GmbH

(21) Appl. No.: 12/669,160

(22) PCT Filed: Jul. 1, 2008
(86) PCT No.: PCT/EP2008/005364

§ 371 Date: Jun. 21, 2010

(30) Foreign Application Priority Data
Jul. 19, 2007 (DE) 10 2007 033 995.1

(51) Int. Cl. G01D 11/28

(52) U.S. Cl. 116/288

(57) ABSTRACT

The invention relates to a display device having a first displaceable pointer, a second displaceable pointer, a light source, and a display surface, the first pointer and the light source being disposed on a side of the display surface facing away from the visible side, the first pointer and the light source being disposed such that light can be emitted from the first pointer toward the display device, and the second pointer being disposed on the visible side of the display surface, the display surface further being at least partially transparent in the region of the light emitted by the first pointer, such that the representation of the first pointer substantially corresponds to the representation of the second pointer.

The invention relates to a display device having a first pointer, a second pointer, a light source and a display surface, the pointer and the light source lying under the display surface.

Such display devices are generally known. Thus, for example, patent specification DE 42 41 719 C2 describes a pointer device for a vehicle having a pointer, the pointer being used to guide the light. However, the device described has the disadvantage that the arrangement of the pointer relative to the display surface must satisfy specific comparatively restrictive conditions and, in addition, also has comparatively few design options as to its visual impression.

It was therefore the object of the present invention to specify a display device in the case of which a subsurface pointer can be designed as simply as possible and, furthermore, a visual impression that can be formed over wide areas, or a representation of the subsurface pointer that resembles a pointer, is also possible despite a simple and cost-effective design and only slight mounting requirements.

The object is achieved with the aid of a display device having a first moving pointer, a second moving pointer, a light source and a display surface, the first pointer and the light source being arranged on a side facing away from a viewing side of the display surface, the first pointer and the light source being arranged in such a way that light can be emitted from the first pointer in the direction of the display surface, the second pointer being arranged on the viewing side of the display surface, and, furthermore, at least in the region of the light emitted from the first pointer, the display surface being provided at least partially in a transparent fashion in such a way that the representation of the first pointer essentially corresponds to the representation of the second pointer. This advantageously enables the representation or the visual impression of the first pointer to be kept variable within wide limits and therefore also capable of being adapted to the visual representation of the second pointer, and this overall enables a particularly pleasant and esthetically advantageous appearance of the display device.

Furthermore, it is preferred according to the invention that the representation of the first pointer has a tip, or that the representation of the first pointer is designed substantially “like a pointer”, that is to say in the form of a pointer and, in particular, is adapted to the form or the appearance of the second pointer. This has the advantageous effect of a particularly good visual impression of the inventive display device.

Furthermore, it is preferred according to the invention that the first pointer and/or the second pointer are/is provided in a fashion capable of rotation. It is thereby possible for a conventional display device with round instruments to be configured in a simple way in accordance with the invention.

Furthermore, it is preferred that the light source is arranged in a stationary fashion relative to the first pointer. This enables a particularly simple supply of light to the first pointer by the light source. Furthermore, a simpler and more stable design of the first pointer of the display device is thereby advantageously enabled.

Furthermore, it is preferably also provided that at least one light-emitting diode is provided as light source, in particular a plurality of light-emitting diodes that can emit light in various colors, or a light-emitting diode emitting multicolored light. It is thereby possible to implement in a particularly simple and cost-effective way a first pointer that is lighter and therefore very motionally dynamic as well as, furthermore, also more cost-effective.

It can be preferred according to the invention that the light source produces divergent and/or convergent light, and substantially parallel light effects the representation of the first pointer on the display surface, the first pointer in particular having at least one optical component that provides a transformation of the light of the light source into parallel light. Consequently, it is advantageously possible to make use of any desired light source. It is preferred for the pointer to have at least one optical component. With particular preference, the pointer has more than one optical component. Owing to the optical components, it is preferably possible to transform the light of the light source into parallel light. It is thus particularly advantageous that the pointer takes over not only the task of guiding or directing light through the display device, but in so doing transforms the light additionally into parallel light. Guiding and directing the light through the pointer is to be understood to mean that the pointer receives the light from a light source and guides it to another location. Transformation of the light is intended to be understood in this case to mean when the beam path of the light is changed by means of an optical component or a plurality of optical components. It is particularly preferred for the pointer to have, as optical component, at least a lens, and/or a diaphragm, and/or a prism, and/or an optical waveguide, and/or a mirror. The light is advantageously influenced by the optical components such that a change takes place in the beam path or the light is directed. It is particularly preferred for the diaphragm to prevent light above or below a lens or an optical waveguide from being emitted into the display device or into the interior of the display device. As an alternative to a design with an optical component, it is also possible according to the invention for no such optical component to be present, but for the first pointer to have a particularly simple design.

The invention is explained below with the aid of figures. In this case, the explanations are only exemplary and do not restrict the general idea of the invention.

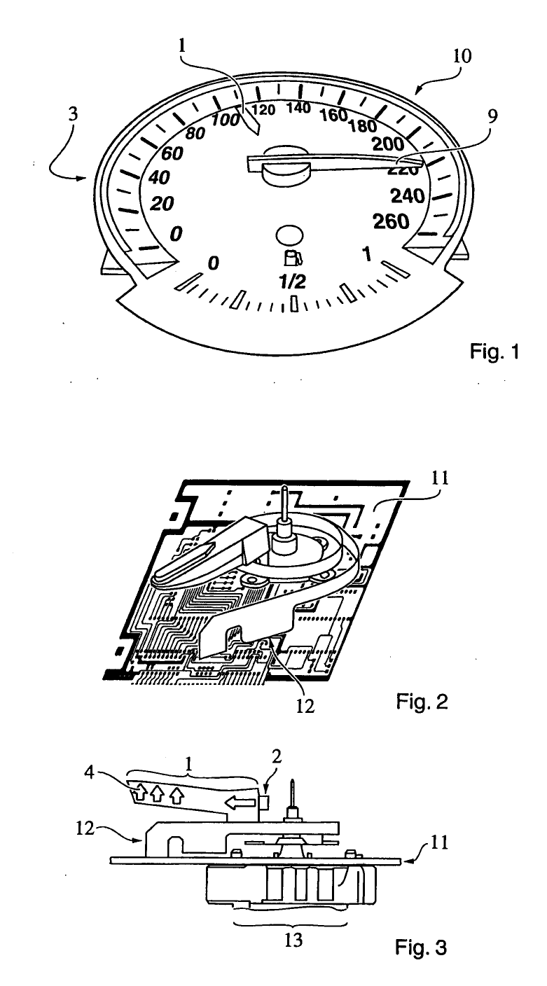

FIG. 1 is a schematic perspective illustration of a display device having a light source and a first and a second pointer.

FIGS. 2 to 4 are various schematic illustrations of the first pointer.

FIG. 5 is a schematic detailed view of the first pointer and the second pointer.

FIG. 1 is a schematic perspective illustration of an inventive display device 10 having a display surface 3. The display device 10, for example as part of a combination instrument and, in particular, in a motor vehicle, has a first pointer 1 and a second pointer 9. The display surface 3 has a viewing side or a front side. The display surface 3 also has a rear side. The second pointer 9 is imaged on the front side or the viewing side of the display surface 3, preferably as a rotating pointer, for example in order to display a value on the display surface 3. Here, the first pointer 1 is arranged underneath the display surface 3, that is to say on the side of the display surface 3 that faces away from a user of the display device 10 (and lies opposite the front side). The display device 10 is designed, in particular, as a round instrument, at least one of the pointers 1, 9, but preferably both pointers 1, 9, respectively being arranged in a fashion capable of rotation and respectively being able to indicate a displayed value. The invention provides in particular here that the first and the second pointer 1, 9 have a common fulcrum, or fulcrums or rotation axes that substantially coincide. However, it is by all means also possible to provide in accordance with the invention that the fulcrums of the first pointer 1 and of the second pointer 9 differ from one another. The second pointer 9 is provided, in particular, in a fashion capable of rotating about a rotation axis running substantially perpendicular to the display surface 3. The first pointer 1, which is located on the rear side of the display surface 3 (or underneath the display surface 3) and is also denoted below as subsurface pointer 1, has a light source 2 that is arranged to represent an item of information visually on the front side of the display surface 3, and is, in particular, arranged in a fashion capable of rotating together with the first pointer 1. However, this is not mandatory in accordance with the present invention, because the light source 2 could also be stationary and arranged underneath the display surface 3. The subsurface pointer 1 is preferably likewise capable of rotation, either about the rotation axis of the second pointer 9, or else about an axis parallel to this rotation axis. A variable referred to speed and/or to rotational speed, or else any other variable relating to the vehicle or relating to comfort, for example the instantaneous speed and a recommended speed or a target speed (for example of a cruise controller), can, for example, be provided as displayed values of the pointers 1, 9.

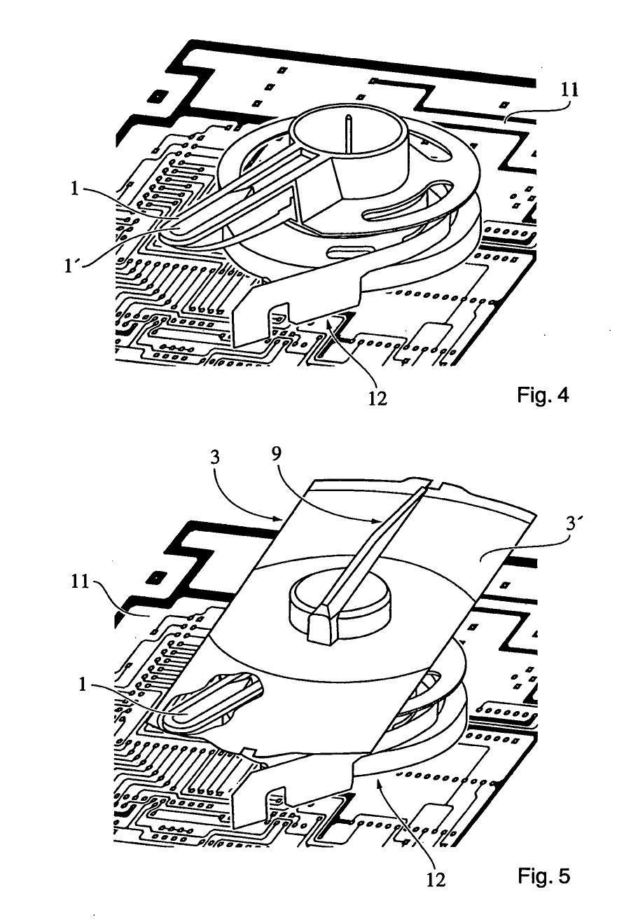

FIGS. 2 and 4 schematically different detailed illustrations of the first pointer 1 in accordance with perspective illustrations, while FIG. 3 illustrates a side view. Here, the first pointer 1 is particularly arranged in accordance with the invention above a printed circuit board 11 of the inventive display device 10. The display surface 3 is not illustrated in FIGS. 2 to 4. The first pointer 1 has the light source 2 by means of which light 4 is emitted. Here, the light source 2 can, in particular, be designed as a light-emitting diode, or else as a plurality of light-emitting diodes. The light 4 or a light beam 4 is displayed on the display surface 3 or on the front side of the display surface 3 via, in particular, an optical waveguide integrated in the first pointer 1, the light beam 4 falling in the process onto the display surface 3 from its rear side. The visible light 4 on the display surface 3 is, in particular, substantially parallel light 4, but it can also be divergent light 4. Here, the first pointer 1 has, in particular, a light exit surface 1′ for emitting the light 4 or the light beam 4 in the direction of the display surface 3, which can be optically adapted to the display requirements in a wide range, for example in such a way that the representation of the first pointer 1 substantially corresponds to the representation of the second pointer 2. The display surface 3 is provided in an at least partially transparent or partially light-transmitting fashion at least in that subregion over which the intention is to display the light 4 of the first pointer 1 from the rear side of the display surface 3 on the front side of the display surface 3. Consequently, the light beam 4 is visible to a user of the display surface 3 as an item of optical information on its front side. The light source 2 is electrically connected by means, in particular, of a flexible conductor track 12 or of a flexible cable 12, produced in the manner of a flexible printed circuit board, for example, or of an electrical connection 12, the flexible conductor track 12 extending, in particular in the shape of a spiral, at least at the beginning, and therefore at least partially following the rotary movement of the first pointer 1. Likewise illustrated in FIG. 3, in particular, is a motor 13 for driving the first pointer 1 and/or the second pointer 9.

The first pointer 1 and the second pointer 9 are depicted schematically in FIG. 5 in a detailed view of the display device 10 illustrated partially in a cutaway fashion. A segment of the display surface 3 is also illustrated in FIG. 5.

A region of the display surface 3 is visible that runs radially in the region 3′ of the first pointer 1 and is designed in a partially transparent fashion so that the light 4 generated by the light source 2 can be displayed on the display surface 3 via the first pointer 1.

### LIST OF REFERENCE NUMERALS

1 First pointer
1′ Light exit surface
2 Light source
3 Display surface
3′ Region of the first pointer
4 Light/light beam
9 Second pointer
10 Display device
11 Printed circuit board
12 Conductor track
13 Motor

1. A display device (10) having a first moving pointer (1), a second moving pointer (9), a light source (2) and a display surface (3), the first pointer (1) and the light source (2) being arranged on a side facing away from a viewing side of the display surface (3), the first pointer (1) and the light source (2) being arranged in such a way that light (4) can be emitted from the first pointer (1) in the direction of the display surface (3), and the second pointer (9) being arranged on the viewing side of the display surface (3), characterized in that, at least in the region of the light (4) emitted from the first pointer (1), the display surface (3) is provided at least partially in a transparent fashion in such a way that the representation of the first pointer (1) essentially corresponds to the representation of the second pointer (2).

2. The display device (10) as claimed in claim 1, characterized in that the light source (2) produces divergent and/or convergent light, and substantially parallel light (4) effects the representation of the first pointer (1) on the display surface (3), the first pointer (1) in particular having at least one optical component that provides a transformation of the light of the light source (2) into parallel light (4).

3. The display device (10) as claimed in claim 1, characterized in that the representation of the first pointer (1) has a tip.

4. The display device (10) as claimed in claim 1, characterized in that the first pointer (1) and/or the second pointer (9) are/is provided in a fashion capable of rotation.

5. The display device (10) as claimed in claim 1, characterized in that the light source (2) is arranged in a stationary fashion relative to the first pointer (1).

6. The display device (10) as claimed in claim 1, characterized in that at least one light-emitting diode is provided as light source (2), in particular a plurality of light-emitting diodes that can emit light in various colors, or a light-emitting diode emitting multicolored light.
